(19) United States
(12) Patent Application Publication
(10) Pub. No.: US 2024/0417540 A1
(43) Pub. Date: Dec. 19, 2024

(54) PLASTICIZER FOR POLYMER RESIN COMPOSITIONS

(71) Applicant: Dow Global Technologies LLC, Midland, MI (US)

(72) Inventors: Abhisar Jain, Mumbai (IN); Debatosh Baidya, Wiesbaden (DE)

(21) Appl. No.: 18/718,854

(22) PCT Filed: Nov. 2, 2022
(86) PCT No.: PCT/US2022/079128

§ 371 Date: Jun. 12, 2024

(30) Foreign Application Priority Data
Dec. 20, 2021 (IN) 202141059280

(51) Int. Cl. C08K 5/11; C08J 3/18

(52) U.S. Cl. CPC C08K 5/11; C08J 3/18; C08J 2309/04

(57) ABSTRACT

A plasticized rubber polymer composition including a mixture of: (a) at least one propylene oxide-based glycol ether ester plasticizer component; wherein the at least one propylene oxide-based glycol ether ester plasticizer component; and (b) at least one rubber polymer resin component to form a plasticized rubber polymer composition mixture of the at least one propylene oxide-based glycol ether ester plasticizer component and the at least one rubber polymer resin component, wherein the plasticized rubber polymer composition mixture is stable at a low temperature; a process for producing the above composition; and an article made from the above composition.

### FIELD

The present invention relates to plasticizers useful as an additive for polymer resin compositions; and more specifically, the present invention relates to propylene oxide-based glycol ether ester plasticizers useful for plasticizing polymer resin compositions.

### BACKGROUND

Plasticizers are used in polymers to create desired physical characteristics in the resulting polymer/plasticizer mixture composition. Some of the desired physical characteristics of the mixture composition may include increasing the flexibility, pliability, and plasticity properties of the resultant polymer/plasticizer mixture composition. Phthalates have been extensively used in rubber formulations as a plasticizer additive. For example, phthalates are added to nitrile butadiene rubber (NBR) to improve processing parameters or to reduce the cost of the process.

Heretofore, the most common plasticizer used in NBR compounds has been a combination of di-2-ethylhexyl phthalate (DEHP) and dioctyl phthalate (DOP). However, DEHP/DOP is not currently recommended to be used as a plasticizer additive for polymer resins due to the material's toxicity. For example, DEHP/DOP is labeled as “prohibited” in the Global Automotive Declarable Substance List (GADSL). In addition, the existing product formulations based on phthalate/non phthalate plasticizers have problems with stability at low temperatures, resistance to heat at high temperatures, and the occurrence of “blooming” in articles made from the existing product formulations. The industry has searched for a plasticizer additive having none of the above-mentioned problems without much success.

Accordingly, it is desired to provide suitable plasticizers for use in polymer resins, such as NBR, that do not have the toxicological issues associated with DOP and other phthalates. Also, it is desired to provide a suitable acceptable plasticizer for use in NBR polymer resins; and for imparting the desired benefits to NBR polymer resins.

### SUMMARY

In one aspect, the present invention relates to a plasticized rubber polymer composition that comprises a mixture of:
(a) at least one propylene oxide-based glycol ether ester plasticizer component; wherein the at least one propylene oxide-based glycol ether ester plasticizer component has the following structure:

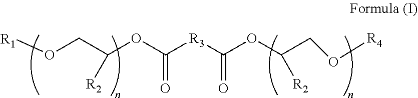

wherein R₁ and R₄ independently are C₁-C₈ alkyl groups, phenyl or benzyl; R₂ independently is either hydrogen, methyl or ethyl; n is independently 1 to 4; and R₃ is a carbon chain containing 0 to 5 carbon atoms and optionally a double bond; and
(b) at least one rubber polymer resin component; wherein a plasticized rubber polymer composition mixture is formed comprising the at least one propylene oxide-based glycol ether ester plasticizer component and the at least one rubber polymer resin component.

In another aspect, the present invention relates to a process for plasticizing a rubber polymer composition that comprises mixing:
(a) at least one propylene oxide-based glycol ether ester plasticizer component; wherein the at least one propylene oxide-based glycol ether ester plasticizer component has the following structure:

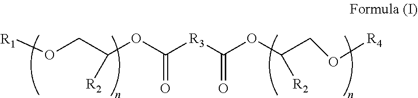

wherein R₁ and R₄ independently are C₁-C₈ alkyl groups, phenyl or benzyl; R₂ independently is either hydrogen, methyl or ethyl; n is independently 1 to 4; and R₃ is a carbon chain containing 0 to 5 carbon atoms and optionally a double bond; and
(b) at least one polymer resin component; wherein a plasticized rubber polymer composition mixture comprising the at least one propylene oxide-based glycol ether ester plasticizer component and the at least one rubber polymer resin component is formed.

In another aspect, the present invention is directed to a process for plasticizing a polymer composition including mixing: (a) at least one glycol ether-based plasticizer component; wherein the at least one glycol ether-based plasticizer component comprises a non-VOC material having a boiling point of greater than 350° C.; and (b) at least one polymer resin component to form a polymer resin component and a plasticizer composition mixture. In some embodiments, the composition mixture exhibits several beneficial properties including for example: low temperature stability based on the composition being measured at a temperature of −40° C.; heat resistance based on the composition being measured at a temperature of 200° C. for 1 hour; and a decreased blooming effect.

In some embodiments, the plasticizer additive of the present invention includes an adipate (bis-dipropylene glycol n-butyl ether adipate, also called di-[2-(2-butoxy-1-methylethoxy)-1-methylethyl] adipate and abbreviated “b-DPGBEA”) which is a P-series (propylene oxide-based glycol ether) glycol ether adipate.

In other embodiments, the present invention is directed to the use of b-DPGBEA as a plasticizer for rubber processing applications. In some embodiments, for example, the present invention pertains to the use of b-DPGBEA as a plasticizer for NBR rubbers.

Various embodiments of the present invention are described in more detail in the following Detailed Description.

### DETAILED DESCRIPTION

Unless stated to the contrary, implicit from the context, or customary in the art, all temperatures used herein are in degrees Celsius (° C.).

“Room temperature (RT)” and “ambient temperature” herein means a temperature between 20° C. and 26° C., unless specified otherwise.

Unless stated to the contrary, implicit from the context, or customary in the art, all percentages, parts, ratios, and the like amounts, are defined by weight. For example, all percentages stated herein are weight percentages (wt %), unless otherwise indicated.

The term “composition,” as used herein, refers to a mixture of materials which comprises the composition, as well as reaction products and decomposition products formed from the materials of the composition.

An “elastomer” is a polymer with viscoelasticity (i.e., both viscosity and elasticity) and with weak intermolecular forces, generally low Young's modulus and high failure strain compared with other materials. IUPAC (International Union of Pure and Applied Chemistry) defines the term “elastomer” as a “polymer that displays rubber-like elasticity.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤;” means “less than or equal to”; ≥” means “greater than or equal to”; “@” means “at”; ppm=parts per million; ppb=parts per billion; ppt =parts per trillion; BV/hr=bed volume/hour(s); “MT”=metric ton(s); g=gram(s); mg=milligram(s); Kg=kilogram(s); L=liters; g/L=gram(s) per liter; μL=microliter(s); “g/cm³” or “g/cc”=gram(s) per cubic centimeter; g/10 min=gram(s) per 10 minutes; mg/mL=milligrams per milliliter; Kg/m³=kilogram(s) per cubic meter; Kg_{f}/cm²=kilogram(s)-force per square centimeter; ppm=parts per million by weight; pbw=parts by weight; phr=parts per hundred resin; RPM=revolutions per minute; m=meter(s); mm=millimeter(s); cm=centimeter(s); m=micron(s) or micrometer(s); nm=nanometer(s); min=minute(s); s=second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; ° C./min=degree(s) Celsius per minute; psi=pounds per square inch; kPa=kilopascal(s); %=percent; vol %=volume percent; mol %=mole percent; and wt %=weight percent.

Specific embodiments of the present invention are described herein below. These embodiments are provided so that this disclosure is thorough and complete; and fully conveys the scope of the claimed subject matter of the present invention to those skilled in the art.

In one broad embodiment, the present invention is directed to a plasticized rubber polymer composition including a mixture of: (a) at least one propylene oxide-based glycol ether ester plasticizer component having a boiling point of greater than 350° C. and a molecular weight of greater than 450 g/mol; (b) at least one rubber polymer resin component; and (c) one or more optional components, if desired, to form a plasticized rubber polymer composition. The resultant plasticized rubber polymer composition comprising a mixture of the above components (a), (b). and optionally (c), exhibits several advantageous properties. For example, the desired benefits for the resultant plasticized rubber polymer composition of the present invention include: (1) stability at low temperatures, for example low temperature stability based on the composition being measured at a temperature of −40° C.; (2) resistance to heat at high temperatures, for example based on the composition being measured at a temperature of 200° C. for 1 hour; and (3) a decreased (reduction), or elimination of, the “blooming” effect in rubber articles made from the resultant plasticized rubber polymer composition of the present invention during rubber processing. Blooming is a surface phenomenon occurring on the surface of the rubber article made from a plasticized rubber polymer composition. Blooming is determined by visual observation and a low, or no, blooming effect occurs when the surface of the rubber article produced from the plasticized rubber polymer composition is aesthetically pleasing to the naked eye, is detected by the visual observation. The desired benefits observed during evaluation of rubber polymer compositions in accordance with the present disclosure may include (1) to (3) above, but may be present in similar trends at differing values in different formulations, processes, and applications.

Component (a) of the plasticized rubber polymer composition of the present invention includes at least one (one or more) propylene oxide-based glycol ether ester plasticizer components which can be one or more bis (glycol ether) alkylates.

The one or more bis(glycol ether) alkylates may correspond to the following general Formula (I):

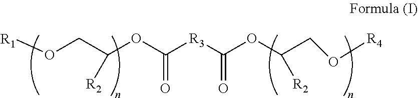

wherein R₁ and R₄ independently are C₁-C₈ alkyl groups, phenyl or benzyl; R₂ independently is either hydrogen, methyl or ethyl; n is independently 1 to 4; R₃ is a carbon chain containing 0 to 5 carbon atoms and may contain a double bond. In a preferred embodiment R₁ and R₄ are independently C₁-C₈ alkyl groups. R₁ and R₄ can be straight or branched chain alkyl groups. In a preferred embodiment, R₁ and R₄ alkyl groups are straight chained.

In some embodiments, the propylene oxide-based glycol ether ester plasticizer, component (a), useful in the present invention, can include one or more bis(glycol ether) alkylates described in U.S. Patent Application Publication 20210071053A1 and U.S. Pat. No. 9,908,839B2. Exemplary of the one or more bis(glycol ether) alkylates (or bis-glycol ether esters described by Formula (I) above) may comprise one or more of bis-dipropylene glycol n-butyl ether adipate, bis-dipropylene glycol n-propyl ether adipate, bis-diethylene glycol n-butyl ether malonate, bis-diethylene glycol n-butyl ether succinate, bis-dipropylene glycol n-butyl ether maleate, and mixtures thereof. In a preferred embodiment, the one or more bis(glycol ether) alkylates may comprise one or more of bis-dipropylene glycol n-butyl ether adipate (“b-DPGBEA” or “DPnB”). The one or more bis(glycol ether) alkylates may be prepared, for example, using the process disclosed in U.S. Pat. No. 9,908,839B2.

The concentration of the propylene oxide-based glycol ether ester plasticizer, component (a), used in the plasticized rubber polymer composition of the present invention can be, for example, from 3 phr (1.4 wt %) to 10 phr (4.15 wt %) in one general embodiment; from 3 phr (1.4 wt %) to 8 phr (3.4 wt %) in another embodiment; and from 4 phr (1.9 wt %) to 6 phr (2.5 wt %) in still another embodiment based on the total weight of the compounds in the composition.

Some of the advantageous properties of the propylene oxide-based glycol ether ester plasticizer, component (a), before the propylene oxide-based glycol ether ester plasticizer is mixed with the rubber polymer resin component, component (b); include for example, component (a) has a low VOC (volatile organic compound(s)) content, a high boiling point, and a high molecular weight; and component (a) is not a hazardous air pollutant.

For example, the propylene oxide-based glycol ether ester plasticizer is a non-VOC compound; or the propylene oxide-based glycol ether ester plasticizer has a low VOC content in the glycol ether plasticizer. In a general embodiment, the concentration of VOCs present in the plasticizer is as close to zero wt % as possible to be useful as a “non-VOC content” or “low VOC content” plasticizer. Thus, by “non-VOC content” or “low VOC content” with reference to the plasticizer, it is meant that the plasticizer has a contamination amount of VOC compounds (or components) of less than 1 wt % of VOC components. In other embodiments, the VOC content in the plasticizer can be from 0.001 wt % to less than 2 wt % in one general embodiment; and from 0.01 wt % to 1.0 wt % in another embodiment. In some instances, the contamination amount of VOC compounds present in the plasticizer are not intentionally added to the plasticizer; but instead, may originate from a separate source, for example during manufacture, delivery, storage, or processing of the plasticizer. In another embodiment, the amount of volatile organic compounds of less than 1 wt % in the one or more bis(glycol ether) alkylates may be defined by EPA Method 24.

In some embodiments, the boiling point of the propylene oxide-based glycol ether ester plasticizer is generally >350° C. up to 500° C. in one embodiment; from 430° C. to 500° C. in another embodiment; from 450° C. to 500° C. in still another embodiment; and from 470° C. to 500° C. in yet another embodiment. Unless otherwise stated herein, the boiling point above 350° C. at 760 mmHg is measured using the procedure described in the 2004/42/EC Solvents Directive for Decorative Paints.

In some embodiments, the propylene oxide-based glycol ether ester plasticizer may exhibit color of less than 25 APHA, as measured ASTM D1209.

In some embodiments, the molecular weight of the propylene oxide-based glycol ether ester plasticizer is >450 g/mol in one general embodiment; and from 450 g/mol to 550 g/mol in another embodiment.

By “nonhazardous”, with reference to a propylene oxide-based glycol ether ester plasticizer, it is meant that the plasticizer is a non-toxic, low VOC, and environmentally friendly compound.

In general, the rubber polymer resin component, component (b), useful in the present invention can include one or more rubber polymer resin components. For example, the rubber polymer resin component useful in the present invention may include various synthetic rubber products manufactured by emulsion-polymerizing acrylonitrile and butadiene, e.g., nitrile butadiene rubber (NBR) (also referred to as “nitrile rubber”) is a family of unsaturated copolymers of butadiene (BD) and acrylonitrile (ACN). In general, component (b) is a medium-high viscosity, cold polymerized polymer of acrylonitrile and butadiene rubber; i.e., a cold polymerized, medium ACN containing acrylonitrile butadiene co-polymer.

In some embodiment, the rubber polymer resin, component (b), can include, for example, various commercially available products such as: KNB 35L (available from Kumho Petrochemical); Perbunan 3445 F and Krynac 3345 F (both available from Arlanxeo); Nipol® DN1201L (available from Zeon Chemicals); Nancar® 3345 (available from Nantex Industry Co., LTD.); Apcoflex N746 (available from Apcotex Industries limited); and mixtures thereof.

In one preferred embodiment, the rubber polymer resin component useful in the present invention includes, but is not limited to, for example, Kumho KNB 35L, Apcoflex N746, Perbunan 3445; and mixtures thereof.

The concentration of the rubber polymer resin component used in the present invention can be, for example, from 30 wt % to 60 wt % in one general embodiment, and from 40 wt % to 55 wt % in another embodiment, based on the total weight of the compounds in the composition.

In general, the rubber polymer resin component, component (b), before the rubber polymer resin component (b) is mixed with the propylene oxide-based plasticizer, component (a), includes various beneficial properties such as, for example, component (b) is oil resistant which is advantageous because component (b) can then be used for articles such as fuel hoses, oil seals, gaskets and other articles or products where the lowest oil swell properties are needed.

In some embodiments, the resultant plasticized rubber polymer composition mixture of components (a) and (b) of the present invention can further include one or more optional components, additives or other agent compounds, if desired. The optional compounds, component (c), useful in the plasticized rubber polymer composition mixture of the present invention can include, for example, other polymer resins, activators, other plasticizers, accelerators, curing agents, desiccants, antioxidants, waxes, fillers, lubricants, plasticizers, pigments, dyes, stabilizers, nucleating agents, flame retardants, blowing agents, curatives, and mixtures thereof.

In some embodiments of optional additives useful in the present invention, include for example, but not are limited to, the following: from 5 phr (2.47 wt %) to 10 phr (4.15 wt %) of zinc oxide; from 1.5 (0.74 wt %) to 4 phr (1.66 wt %) of stearic acid; from 2 phr (0.99 wt %) to 3 phr (1.25 wt %) of (2, 2, 4-trimethyl-1, 2-dihydroquinoline); from 2 phr (0.99 wt %) to 3 phr (1.25 wt %) of (4, 4′-bis (alpha, alpha-dimethyl benzyl) diphenylamine; from 3 phr (1.48 wt %) to 5 phr (2.08 wt %) of wax; from 5 phr (2.47 wt %) to 10 phr (4.15 wt %) of silica; from 70 phr (34.60 wt %) to 80 phr (33.24 wt %) of carbon black; from 3 phr (1.48 wt %) to 10 phr (4.15 wt %) of other plasticizers; from 1.7 phr (0.79 wt % to 1.9 phr (0.84 wt %) of DTDM; from 1.8 phr (0.89 wt %) to 2.2 phr (0.91 wt %) of TMTM; 2 phr (0.99 wt %) to 2.8 phr (1.16 wt %) of CBS; 0.3 phr (0.15 wt %) to 0.8 phr (0.33 wt %) of sulphur; from 5 phr (2.47 wt %) to 8 phr (3.32 wt %) of CaO; and mixtures thereof.

In some preferred embodiments, although optional, some of the above optional additives are important and can be added to the resultant plasticized rubber polymer composition mixture.

For example, an antioxidant compound may be added to the resultant plasticized rubber polymer composition mixture because an antioxidant can be used to maintain the heat aging properties for the rubber component such as NBR. NBR has a lot of unsaturation which may prone to thermal degradation without an antioxidant component. The concentration of the antioxidant additive used in the present invention can be, for example, from 1.0 wt % to 4.5 wt % in one general embodiment, and from 1.5 wt % to 2.5 wt % in another embodiment, based on the total weight of the compounds in the composition.

In another embodiment, for example, a curative compound can be added to the resultant plasticized rubber polymer composition mixture to cure the composition and form the final rubber product. The concentration of the curative additive used in the present invention can be, for example, from 0.1 wt % to 0.8 wt % in one general embodiment, and from 0.1 wt % to 0.4 wt % in another embodiment, based on the total weight of the compounds in the composition.

In general, the total concentration of all of the optional compounds, component (c), when used in the plasticized rubber polymer composition mixture, includes, for example, from 40 wt % to 60 wt % in one embodiment, and from 45 wt % to 55 wt % in another embodiment, based on the total weight of the compounds in the composition.

In a broad embodiment, a process for preparing the blend or mixture of the propylene oxide-based glycol ether ester plasticizer component (a) and the rubber polymer resin component, component (b), and any desired optional components, component (c), to provide a plasticized rubber polymer resin composition includes, for example, mixing: (a) the at least one propylene oxide-based glycol ether ester plasticizer component; (b) the at least one rubber polymer resin component; and one or more optional components (c), to form a plasticized polymer resin composition mixture useful in the present invention; wherein the plasticized polymer resin composition mixture exhibits a low temperature stability of, for example, as measured at a temperature of −40° C.; a high temperature heat resistance, for example, as measured at a temperature of 200° C. for 1 hour; and a low blooming effect, for example, when no detectable amount of plasticizer particles migrate to the surface of the rubber article made from the plasticized rubber polymer composition of the present invention.

The temperature of the mixing step in the above general process can be, for example, from 25° C. (i.e., room temperature) to up to 125° C.

The above process of the present invention for preparing a plasticized polymer resin composition, can be carried out by conventional equipment known to those skilled in the art. For example, the mixing step to form the plasticized rubber polymer composition can be carried out by commonly known mixers such as an intermix, a Banbury mixer, a kneader, and the like. When heating the result mixture, the heating can be carried out by heaters commonly known in the art such as machine fitted thermocouples.

In other embodiments, the process of producing a plasticized rubber polymer composition, i.e., a process for plasticizing a rubber resin to form the plasticized rubber polymer composition, includes the steps of:
Step (I): providing at least one propylene oxide-based glycol ether ester plasticizer component, at least one rubber polymer resin component, and any one or more desired optional components;
Step (II): intermittently adding one or more ingredients of step (I) to a mixer to produce plasticized polymer resin composition

The process can include one or more optional steps and/or one or more process conditions for the optional steps. For example, in the preliminary mixing of rubber can take place at room temperature followed by a mastication step wherein the mastication step can take place at a temperature of 50° C.; wherein during the mastication step, other additives can be added to the mixture; and wherein the batch formed after the mastication step can be dumped at a temperature of 125° C.

In some embodiments, the temperature of the mixing step (II) of the above process can be, for example, from room temperature (RT; 25° C.) up to 130° C. in one general embodiment; from RT up to 125° C. in another embodiment; from 25° C. to 50° C. in another embodiment. The process embodiments of the present invention described above for preparing a plasticized polymer resin composition, and the steps thereof as described above, can be carried out by conventional equipment known to those skilled in the art.

Some advantageous properties and/or benefits exhibited by the plasticized polymer resin composition produced by the process of the present invention include, for example, the composition is stable at low temperatures such as below −40° C. By “stability” at low temperatures, with reference to the plasticized polymer resin, means passing a bend test at −40° C. The bend test used for testing the plasticized polymer resin of the present invention is described in ASTM D 1329/16 2021. In some embodiments, the plasticized polymer resin is stable (i.e., has a low temperature stability) at a temperature measured at −40° C. The low temperature stability of the plasticized polymer resin is measured by the procedure described, for example, in ASTM D 1329/16 2021.

In other embodiments, the plasticized polymer resin of the present invention advantageously exhibits heat resistance. For example, the “heat resistance” of a plasticized rubber article is measured by the bend test procedure described in ASTM D 573/04 2019. Generally, in the bend test a plasticized rubber article sample is subjected to a temperature of 200° C. for 1 hr; and then cooled to room temperature on a flat surface. Upon undergoing the bend test, if the article does not show signs of cracks upon visual inspection, the plasticized rubber article is deemed to be heat resistance. If any cracks are observed on the plasticized rubber article test sample after 1 hr at the temperature of from 200° C., the article fails the heat resistance test.

The plasticized polymer resin has a low blooming effect or no blooming effect as determined by visual observation. The “blooming” effect or “bloom” or “blooming”, with reference to the plasticized polymer resin, is a well-known phenomenon in the art and blooming refers to that phenomenon of a liquid or solid compounding agent moves from the inside of a rubber part containing the agent to the surface of the rubber part to cause whitening of the rubber part or article. Thus, “bloom” is a milky dusting of dry powder on the surface of a rubber part or article. Typically, blooming is caused by unused vulcanizing agent(s) migrating to the surface of a rubber part. For example, “bloom” occurs when plasticizers, additives or other components present inside the rubber part tend to migrate to the surface of the rubber part and creates a color change, usually white, and the white is called “bloom”. In another example, a component called a “stabilizer” typically is deliberately engineered into the rubber to prevent “dry rot” because dry rot is usually triggered by UV Light and tends to make rubber brittle; and when the stabilizer migrates to the surface of the rubber part bloom is formed.

In some embodiments, the blooming effect is determined at the following conditions: a temperature of 60° C. and a relative humidity in the range of from 50 percent to 95 percent.

After producing the plasticized polymer resin as described above, in another broad embodiment, the plasticized polymer resin is used to manufacture a rubber article including the steps of: (A) providing a plasticized polymer resin composition as described above; and (B) molding the plasticized polymer resin composition to form an article thereof. An alternative embodiment of step (B) may include extruding the plasticized polymer resin composition to form an article thereof using extrusion processes and equipment know to those skill in the art of extrusion.

The article produced by the above process can be, for example, sheets, shaped articles, rubber seals, gaskets, diaphragms, hoses and the like.

In general, the process conditions for step (B) of the process, i.e., the injection molding step or extrusion step, can include conventional equipment known in the art of injection molding/extrusion and process conditions. The pressure used in step (B), when molding is used, can be 100 kg/cm² to 200 kg/cm² and when extrusion is used, can be, for example, from 4 Kg/cm² to 8 Kg/cm² in one general embodiment.

The article made from the plasticized polymer resin composition of the present invention, which is produced by the process described above, exhibits several advantageous properties and/or benefits including, for example, the article exhibits (1) an increased crack resistance at low temperatures, and (2) a high temperature aging performance including compression set with improved mechanical properties.

In some embodiments, the article exhibits crack resistance at low temperatures, i.e., cracks do not form in the final rubber article, after the article is stored for a period of time of up to 48 hr a temperature of −40° C. The low temperature crack resistance of the article is determined by visual observation.

In some embodiments, the plasticized polymer resin composition of the present invention is used manufacture various articles or products in the rubber seals, gaskets, diaphragms and hoses applications. For example, the plasticized polymer resin composition can be used to make automobile rubber parts such as oil seals, radiator gaskets, fuel hoses, diaphragms, and the like.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

Various terms and designations used in the Inventive Examples (Inv. Ex.) and the Comparative Examples (Comp. Ex.) are explained as follows:
“DOP” stands for dioctyl phthalate.
“DTDM” stands for 4,4′dithiodimorpholine.
“TMTM” stands for tetramethylthiuram monosulfide.
“CBS” stands for N-cyclohexyl-2-benzothiazolesulfenamide.
“ML” stands for or means minimum torque recorded.
“MH” stands for or means maximum torque recorded.
“MH-ML” stands for or means torque difference.
“ts2” stands for or means scorch time/induction time.
“tc90” stands for or means optimum curing time.

### Raw Materials

Table I describes some of the raw materials (ingredients, additives or compounds) used in the Examples; and Table II describes the formulations made using ingredients from Table I and other ingredients described in Table II.

TABLE I
Ingredients

| | Brief | |
|---|---|---|
| Component | Description of | |
| (Ingredient) | Component/Function | Supplier |
| Rubber 746 (NBR) | Polymer resin, | AB Brothers |
| | nitrile rubber | (Apcoflex) |
| Carbon 550 | Reinforcing filler, | AB Brothers |
| | carbon black | (Aditya Birla) |
| DOP | Plasticizer1 | KLJ plasticizer |
| Adipate Polyester | Plasticizer2 | Adeka |
| b-DPGBEA | Plasticizer3 | The Dow Chemical |
| | | Company |

TABLE II
Formulations

| | | Examples | | |
|---|---|---|---|---|
| | | Comp. | | |
| | Brief Description | Ex. A | Comp. | Inv. |
| Compound | of Compound or | (Control) | Ex. B | Ex. 1 |
| (Ingredient) | its Function | (phr) | (phr) | (phr) |
| Rubber 746 | Polymer resin, | 100 | 100 | 100 |
| | nitrile rubber | | | |
| DOP | Plasticizer1 | 5 | 0 | 0 |
| Adipate polyester | Plasticizer2 | 0 | 5 | 0 |
| b-DPGBEA | Plasticizer3 | 0 | 0 | 5 |
| (2, 2, 4-trimethyl- | Antioxidant | 2 | 2 | 2 |
| 1, 2-dihydroquinoline) | | | | |
| Zinc oxide | Activator | 5 | 5 | 5 |
| Stearic acid | Activator | 1.5 | 1.5 | 1.5 |
| (4, 4′-bis (alpha, | Antioxidant | 2 | 2 | 2 |
| alpha-dimethylbenzyl) | | | | |
| diphenylamine | | | | |
| Wax | Antioxidant | 3 | 3 | 3 |
| Silica | Reinforcing Filler | 5 | 5 | 5 |
| Carbon 550 | Reinforcing Filler | 70 | 70 | 70 |
| DTDM | Accelerator | 1.7 | 1.7 | 1.7 |
| TMTM | Accelerator | 1.8 | 1.8 | 1.8 |
| CBS | Accelerator | 2 | 2 | 2 |
| Sulphur | Curing agent | 0.3 | 0.3 | 0.3 |
| CaO | Desiccant | 5 | 5 | 5 |

### General Procedure for Preparing Samples for Testing

The plasticized polymer resin composition of the present invention and articles made therefrom were prepared using a mixer having a mixing chamber and a ram. In this procedure, a fill factor is used and generally is from 0.70 to 0.75. The fill factor is the ratio of the volume of the mixing material in the mixing chamber of the mixer. If the fill factor is too small, the ram reaches to its bottom-most position too early, leading to the ram pressure being too low for efficient shearing and elongation action. In general, the mixer volume is optimized at up to 75%. The mixer volume is maintained at 75% or less because nitrile rubber has a very high modulus; and more than 75% may create wear and tear to the ram, long term, because of the higher modulus of the material.

In this general procedure, a plasticized polymer resin composition of the present invention is prepared; and article samples for testing were made from the plasticized polymer resin composition. The compounds described in Table II were mixed together in the mixer at an initial mixing temperature of 50° C. Rubber 746 (nitrile rubber (NBR)) was first added to the mixer and masticated for 60 s; and then additives including stearic acid, ZnO with oil plus carbon black and other fillers were added to the mixer and mixed into the masticated rubber. The additives were added at 50 RPM for 60 s. Then, the ram was activated, the fillers, which may deposit on the surface of the ram, were swiped and cleaned off of the surface of the ram. Thereafter, the ingredients in the mixing chamber were mixed further until the temperature of the mixer reached 125° C. After mixing, the resultant mixture (the material or the batch) was unloaded (i.e., discharged) from the mixing chamber of the mixer onto a tray.

Mixing was completed using a 6-inch (0.15-m) two-roll mill. A 0.5-inch (0.012-m) thick compound was formed into a sheet and the resultant rubber sheet was kept at room temperature for maturation. Maturation of compound after mixing can help polymer filler interaction better and improves the final properties of the compound.

After 12 hr of compound maturation was carried out as described above, a final batch mixing was done so that the polymer filler interaction (networking) can be optimized. This final mixing step was done by adding the remaining chemicals and additives of the composition including for example, the curatives; and then, thoroughly mixing the resultant mixture in the two-roll mill. After 1 hr of batch mixing all of the ingredients using the two-roll mill, the resultant maturated compound is used for all relevant testing described below including rheology testing using a moving die rheometer (MDR).

### Test Methods and Measurements

### Blooming Test

Several samples of rubber articles or products were tested for blooming using the following procedure: A first cycle, Cycle 1, was performed on the rubber article samples by first placing the samples in a humidity chamber for 7 days at 60° C. and 50% relative humidity (RH); and then, the samples were taken out of the humidity chamber. Subsequently, the samples were kept at room temperature for 2 days; and then, the surface of each of the samples was checked visually, with the naked eye, to determine by visual observation, if a layer of white substance or particles was present on the surface of the samples. The blooming test results, after Cycle 1, shows that there was no layer of white substance or white particles observed on the surface of the samples, i.e., no blooming was observed.

A second cycle, Cycle 2, was performed on several rubber article samples as follows: the samples were placed in a humidity chamber for 4 days at 60° C. and 95% RH; and then, the samples were taken out of the humidity chamber. Subsequently, the samples were kept at room temperature for 2 days; and then, the surface of each of the samples was checked visually, with the naked eye, to determine by visual observation, if a layer of white substance or particles was present on the surface of the samples. The blooming test results, after Cycle 2, shows that there was no layer of white substance or white particles observed on the surface of the samples, i.e., no blooming was observed. The blooming performance was similar across all evaluated sample products.

### Rheology Test Measurements

The rheology of cured kinetic compounds, which were cured at 175° C. for 3 min, was measured, at 0.5° Arc, using an Alpha Moving Die Rheometer (MDR-2000) after the compound was processed using the procedure in ASTM D5289-19 as described above. The results of the rheology measurements are described in Table III.

TABLE III
Rheology Properties

| Property | DOP | Adipate Polyester | b-DPGBEA |
|---|---|---|---|
| ML, Nm | 5.73 | 6.34 | 10.47 |
| MH, Nm | 10.40 | 11.90 | 16.80 |
| MH-ML, Nm | 4.67 | 5.56 | 6.33 |
| ts2, min | 0.52 | 0.48 | 0.45 |
| tc90, min | 1.15 | 1.15 | 1.10 |

In Table III, “ML (dNm)” means the minimum torque of a compound; torque is a measure of the stiffness and viscosity of vulcanized compound at a given temperature. A lower ML of a compound means higher flowability for the compound. In some instances, an overflow of the compound can create high flash thickness of a component after de-molding, so a controlled flow into a mold is desired. A high ML can be beneficial for injection molding applications. In an injection process, because the compound sample being processed keeps idling in the feeder zone of the injection equipment, the compound needs a high compound ML for better stiffness to have better strength to prevent the compound from elongating. Gradual elongation of compound can cause a short fill in the mold cavity that results in a short fill of the final product. The present invention composition beneficially exhibits a balance of compound properties.

In Table III, “MH (dNm)” means the highest torque recorded on a graph. An increased MH value indicates there is an increase in the crosslinking density. The higher the cross-link density of a composition, the better the rate of cure of the composition in the mold.

In Table III, “MH-ML (dNm)” is the torque difference. The torque difference illustrates the number of cross-linkages that occur and is related to the shear modulus of the compound. The higher the torque difference, the higher the cross-linkages number, and the higher the elastic recoverability and can have longer product life. From the rheological properties it can be observed that b-DPGBEA shows excellent crosslink density (MH-ML) which is very essential for faster curing and higher productivity as well as excellent compression properties of the final product.

In Table III, “ts2” is “scorch time” or the point at which the curing starts. The compound b-DPGBEA shows a very similar or better compound scorch safety—the time during which a rubber compound can be worked at a given temperature before curing begins. which is related to processing b-DPGBEA (and therefore, process safety) compared to other known compounds. For example, when the scorch time (ts2) is too high, the resultant rubber product can exhibit a very dull surface; and when ts2 is too low, the product compound can become unsafe in the process; the product may show preprocess cure tendencies in the extruder/injection molding screw barrel.

In Table III, “tc90” indicates optimum curing time, i.e., 90% cure. In other words, tc90 is a required time for the cured rubber to get 90% of the maximum accomplishable torque. So, shorter optimum curing time (tc90) is advantageous, especially for an injection molding process, because a short optimum curing time helps for shortening the curing cycle time and increasing productivity. The propylene oxide-based glycol ether ester plasticizer, b-DPGBEA, exhibits the lowest tc90. Therefore, b-DPGBEA will have a better rate of cure, which in turn, will have a better productivity compared to the other plasticizers tested, as described in Table IV.

TABLE IV
Properties/Performance

| | Slab | Slab | Req⁽¹⁾ | Act⁽²⁾ | Act | Req | Act | Breaking | Req | Act | |
|---|---|---|---|---|---|---|---|---|---|---|---|
| Batch No. | Width | Thickness | Hardness | Hardness | Load | Tensile | Tensile | Elongation | Elongation | Elongation | Modulus |
| (plasticizer) | (mm) | (mm) | (Nm) | (Nm) | (Kg) | (Kg_{f}/cm²) | (Kg_{f}/cm²) | (%) | (%) | (%) | (Kg/cm²) |
| Batch 1 | 6 | 2.19 | Min⁽³⁾ 67 | 75 | 21.6 | Min 90 | 164.38 | 40 | Min 270 | 358.49 | 8.0 |
| (DOP) | 6 | 2.22 | Min 67 | 80 | 23.2 | Min 90 | 174.17 | 41 | Min 270 | 377.36 | 8.2 |
| | 6 | 2.18 | Min 67 | 78 | 21.6 | Min 90 | 165.14 | 39 | Min 270 | 339.62 | 8.2 |
| | | | Average | 78 | | | 168.00 | | | 358.00 | |
| Batch 2 | 6 | 2.20 | Min 67 | 80 | 21.2 | Min 90 | 160.61 | 37 | Min 270 | 301.89 | 8.2 |
| (Adipate | 6 | 2.16 | Min 67 | 80 | 21.6 | Min 90 | 166.67 | 38 | Min 270 | 320.75 | 8.2 |
| polyester) | 6 | 2.22 | Min 67 | 78 | 23.2 | Min 90 | 174.17 | 40 | Min 270 | 358.49 | 8.4 |
| | | | Average | 79 | | | 167.00 | | | 327.00 | |
| Batch 3 | 6 | 2.48 | Min 67 | 80 | 24.8 | Min 90 | 166.67 | 37 | Min 270 | 301.89 | 9.0 |
| (b-DPGBEA) | 6 | 2.43 | Min 67 | 80 | 26.5 | Min 90 | 181.48 | 38 | Min 270 | 320.75 | 9.8 |
| | 6 | 2.40 | Min 67 | 78 | 27.0 | Min 90 | 187.50 | 38 | Min 270 | 320.75 | 10.0 |
| | | | Average | 79 | | | 179.00 | | | 314.00 | |

Notes for Table V: ⁽¹⁾Req = required; ⁽²⁾Act = “actual” and ⁽³⁾Min = “minimum”.

From Table IV, it can be seen that b-DPGBEA offers excellent tensile and similar elongation even though the slab thickness of b-DPGBEA is thicker compared to DOP and adipate polyester. In all three trials, the hardness of b-DPGBEA was observed to be on the higher side compared to DOP and adipate polyester. Another important observation with b-DPGBEA is higher modulus, which can be beneficial for obtaining a greater green strength of the compound and a greater product strength of the final product. The higher modulus of the compound helps to control blisters on the final product and the green strength of the compound.

1. A plasticized rubber polymer composition comprising a mixture of:
(a) at least one propylene oxide-based glycol ether ester plasticizer component;
wherein the at least one propylene oxide-based glycol ether ester plasticizer component has the following structure: 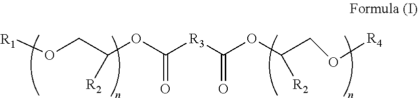
wherein R₁ and R₄ independently are C₁-C₈ alkyl groups, phenyl or benzyl; R₂ independently is methyl or ethyl; n is independently 1 to 4; and R₃ is a carbon chain containing 0 to 5 carbon atoms and optionally a double bond; and
(b) at least one rubber polymer resin component;
wherein a plasticized rubber polymer composition mixture is formed comprising the at least one propylene oxide-based glycol ether ester plasticizer component and the at least one rubber polymer resin component.

2. The plasticized rubber polymer composition of claim 1, wherein the at least one propylene oxide-based glycol ether ester plasticizer component has a has a boiling point of greater than 350° C. up to 500° C. and has a molecular weight of from 450 gm/mol to 550 gm/mol.

3. The plasticized rubber polymer composition of claim 1, wherein the plasticized rubber polymer composition mixture exhibits:
(i) a low temperature stability measured at −40° C.; and
(ii) a product stability under intermittent temperatures of from 175° C. to 200° C.

4. The plasticized rubber polymer composition of claim 1, including further one or more compounds selected from the group consisting of: other polymer resins, activators, other plasticizers, accelerators, curing agents, desiccants, antioxidants, waxes, fillers, lubricants, plasticizers, pigments, dyes, stabilizers, nucleating agents, flame retardants, blowing agents, and mixtures thereof.

5. The plasticized rubber polymer composition of claim 1, wherein the at least one propylene oxide-based glycol ether ester plasticizer component is an adipate.

6. The plasticized rubber polymer composition of claim 1, wherein the at least one rubber polymer resin component is a nitrile rubber.

7. The plasticized rubber polymer composition of claim 1, wherein the concentration of the at least one propylene oxide-based glycol ether ester plasticizer component is from 1.4 weight percent to 4.15 weight percent based on the total weight of the compounds in the composition; and wherein the concentration of the at least one rubber polymer resin component is from 40 weight percent to 60 weight percent based on the total weight of the compounds in the composition.

8. A process for plasticizing a rubber polymer composition comprising the steps of:
(I) providing the following ingredients:
(a) at least one propylene oxide-based glycol ether ester plasticizer component;
wherein the at least one propylene oxide-based glycol ether ester plasticizer component has the following structure: 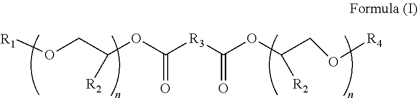
wherein R₁ and R₄ independently are C₁-C₈ alkyl groups, phenyl or benzyl; R₂ independently is methyl or ethyl; n is independently 1 to 4; and R₃ is a carbon chain containing 0 to 5 carbon atoms and optionally a double bond;
(b) at least one polymer resin component; and
(c) optionally, one or more desired optional components; and
(II) intermittently adding one or more ingredients of step (I) to a mixer to produce a plasticized rubber polymer resin composition.

9. A process for manufacturing a rubber article comprising the steps of:
(A) providing a plasticized polymer resin composition of claim 1; and
(B) molding the plasticized polymer resin composition from step (A) to form an article thereof; or extruding the plasticized polymer resin composition from step (A) to form an article thereof.

10. An article comprising an article selected from the group consisting of seals, gaskets, diaphragms, and hoses made by the process of claim 9.

11. The plasticized rubber polymer composition of claim 1, wherein each R₂ is methyl.
